(19) United States
(12) Patent Application Publication
(10) Pub. No.: US 2010/0069150 A1
(43) Pub. Date: Mar. 18, 2010

(54) GAMING SYSTEM AND A METHOD OF GAMING

(76) Inventors: Christer Hutchinson-Kay, Taby (SE); Björn Fredrik Gustaf Jacobson, Stockholm (SE)

Correspondence Address: MCANDREWS HELD & MALLOY, LTD, 500 WEST MADISON STREET, SUITE 3400, CHICAGO, IL, 60661, US

(21) Appl. No.: 12/559,822

(22) Filed: Sep. 15, 2009

(30) Foreign Application Priority Data
Sep. 15, 2008 (AU) 2008904786

(51) Int. Cl. A63F 9/24; A63F 13/00

(52) U.S. Cl. 463/27; 463/30; 463/42

(57) ABSTRACT

A gaming system including a plurality of gaming machines, a display, and a zoom sequence implementer. Each of the plurality of gaming machines implements a probabilistic game and determines when a winning outcome occurs. The gaming system generates a win communication indicative of a winning gaming machine of the plurality of gaming machines when a specific winning outcome occurs at the winning gaming machine, and the zoom sequence implementer receives the win communication to cause location information indicative of the location of the winning gaming machine to be displayed on the display when the win communication is received, and progressively modifies the displayed location information such that the location of the winning gaming machine is progressively shown with more specificity.

### RELATED APPLICATIONS

This application claims priority to Australian Provisional Patent Application No. 2008904786 having a filing date of Sep. 15, 2008, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system and to a method of gaming.

It is known to provide a gaming system which includes a plurality of gaming machines arranged such that each gaming machine implements a probabilistic game. With some such gaming machines, several symbols are randomly selected from one or more sets of symbols and a game outcome is determined based on the displayed symbols. In some arrangements, a win outcome is defined on the basis of occurrence of symbols along defined win lines which may be preselected or selected by a player prior to display of symbols by the gaming system.

It is also known to provide a gaming system wherein multiple gaming machines are associated with each other such that each gaming machine contributes a proportion of game turnover to a jackpot. In one variation, a prize is awarded to a player of a gaming machine when the gaming machine displays a particular game outcome. In an alternative variation, a prize is awarded when the jackpot amount reaches a threshold amount, with the player of the gaming machine causing the threshold to be exceeded being awarded a prize.

### BRIEF SUMMARY OF THE INVENTION

In accordance with a first aspect of the present invention, there is provided a gaming system comprising:

a plurality of gaming machines, each gaming machine being arranged to implement a probabilistic game and to determine when a winning outcome occurs;

a display; and

a zoom sequence implementer;

the gaming system being arranged to generate a win communication indicative of a winning gaming machine of the plurality of gaming machines when a specific winning outcome occurs at the winning gaming machine; and

the zoom sequence implementer being arranged to receive the win communication to cause location information indicative of the location of the winning gaming machine to be displayed on the display when the win communication is received, and to progressively modify the displayed location information such that the location of the winning gaming machine is progressively shown with more specificity.

In one embodiment, the specific winning outcome is a credit win above a specific credit win amount threshold.

In one embodiment, the gaming system comprises a jackpot controller arranged to manage a jackpot associated with the plurality of gaming machines and the specific winning outcome is a jackpot win by one of the gaming machines. The jackpot may be a progressive jackpot wherein each of the gaming machines contributes a portion of credit turnover to a jackpot amount.

In one embodiment, the gaming system is arranged such that when a jackpot win is triggered by a first gaming machine, a first proportion of the jackpot amount is allocated to the first gaming machine, a second gaming machine is selected from the plurality of gaming machines, and a second proportion of the jackpot amount is allocated to the second gaming machine. The first proportion may be the same as or different to the second proportion. The ratio of the first proportion to the second proportion may be 1:2, 2:1, 1:5, 5:1 or any other ratio.

In one embodiment, each gaming machine comprises a display and the zoom sequence implementer is arranged to cause the location information indicative of the location of the winning gaming machine to be displayed on the display.

In addition or alternatively, the gaming system may comprise at least one common display separate to the gaming machines, the zoom sequence implementer being arranged to receive the information indicative of a winning gaming machine associated with the gaming system and to cause location information indicative of the location of the winning gaming machine to be displayed on the common display.

In one embodiment, the zoom sequence implementer is arranged to progressively modify the displayed location information such that the representation of the location of the winning gaming machine is progressively modified by consecutively displaying a plurality of distinct zoom levels.

In an alternative embodiment, the zoom sequence implementer is arranged to progressively modify the displayed location information such that the representation of the location of the winning gaming machine is progressively modified by smoothly changing the location representation.

In one variation, the gaming system comprises a remote base station, and each gaming machine is arranged to generate information indicative of occurrence of a specific winning outcome and to communicate the information through the communications network to the remote base station, the remote base station using the information to generate the win communication and send the win communication to the plurality of gaming machines.

In one embodiment, information indicative of the gaming machines associated with the gaming system, such as the locations of the gaming machines, may be stored at the base station and used to send the win communication to the plurality of gaming machines.

In an alternative embodiment, the information indicative of occurrence of a specific winning outcome generated by a gaming machine may be communicated directly to all gaming machines associated with the gaming system, the information indicative of occurrence of a specific winning outcome including information indicative of the location of the winning gaming machine.

In accordance with a second aspect of the present invention, there is provided a gaming machine for a gaming system including a plurality of gaming machines, the gaming machine being arranged to implement a probabilistic game, the gaming machine comprising:

an interface arranged to receive information indicative of a winning gaming machine;

a display; and

a zoom sequence implementer arranged to cause display of location information indicative of the location of the winning gaming machine to be displayed when information indicative of the winning gaming machine is received, and to progressively modify the displayed location information such that the location of the winning gaming machine is progressively shown with more specificity.

In accordance with a third aspect of the present invention, there is provided a method of gaming, comprising:

providing a plurality of gaming machines;

implementing a probabilistic game at least one gaming machines;

determining whether a winning outcome occurs at the at least one gaming machine;

generating information indicative of a winning gaming machine when a specific winning outcome occurs at the winning gaming machine;

displaying location information indicative of the location of the winning gaming machine when information indicative of the winning gaming machine is received; and

progressively modifying the displayed location information such that the location of the winning gaming machine is progressively shown with more specificity.

In accordance with a fourth aspect of the present invention, there is provided a computer program arranged when loaded into a computing device to instruct the computing device to operate in accordance with a gaming machine comprising:

an interface arranged to receive information indicative of a winning gaming machine associated with a gaming system;

a display; and

a zoom sequence implementer arranged to cause display location information indicative of the location of the winning gaming machine to be displayed when information indicative of the winning gaming machine is received, and to progressively modify the displayed location information such that the location of the winning gaming machine is progressively shown with more specificity.

In accordance with a fifth aspect of the present invention, there is provided a computer readable medium having computer readable program code embodied therein for causing a computing device to operate in accordance with a gaming machine comprising:

an interface arranged to receive information indicative of a winning gaming machine associated with a gaming system;

a display; and

a zoom sequence implementer arranged to cause display location information indicative of the location of the winning gaming machine to be displayed when information indicative of the winning gaming machine is received, and to progressively modify the displayed location information such that the location of the winning gaming machine is progressively shown with more specificity.

### BRIEF DESCRIPTION OF SEVERAL VIEWS OF THE DRAWINGS

The present invention will now be described, by way of example only, with reference to the accompanying drawings, in which:

FIG. 1 is a diagrammatic block diagram of a gaming system in accordance with an embodiment of the present invention;

FIG. 2 is a schematic block diagram of components of a gaming machine of the gaming system shown in FIG. 1;

FIG. 3 is a diagrammatic representation of an example gaming machine of the gaming system shown in FIG. 1;

FIG. 4 is a schematic block diagram of operative components of the gaming machine shown in FIG. 3;

FIG. 5 is a schematic diagram of components of a memory of the gaming machine shown in FIG. 3;

FIG. 6 is a flow diagram illustrating a method of gaming in accordance with an embodiment of the present invention;

FIG. 7 is a representation of location information progressively displayed to a player of a gaming machine during implementation of the method shown in FIG. 6; and

FIG. 8 is a flow diagram illustrating a method of gaming in accordance with an alternative embodiment of the present invention.

### DETAILED DESCRIPTION OF THE INVENTION

The present gaming system operates such that during game play when a specific type of win occurs at one of a plurality of gaming machines, a zoom sequence is initiated on the gaming machines to progressively indicate the location of the winning gaming machine with more specificity and thereby increase excitement amongst players that a significant win is possible and may occur to any of the players.

Referring to the drawings, there is shown a gaming system 10 which comprises a plurality of gaming machines 12, 12′ connected through a network 14 to a base station 16. In this embodiment, the base station 16 is arranged to control and coordinate distribution to the gaming machines 12, 12′ of games, and to control and coordinate implementation of a jackpot, in this example a progressive jackpot.

In this example, operation of the jackpot is such that each gaming machine 12, 12′ associated with the gaming system contributes a portion of turnover to a jackpot pool and at least part of the jackpot pool is awarded to a player of a gaming machine when a jackpot triggering condition occurs at the gaming machine.

The jackpot pool may be created by allocating a credit amount from each gaming machine 12, 12′ to the jackpot pool when credit is added to the gaming machine, when a winning outcome associated with a credit prize occurs, based on gaming machine turnover, or in any other way.

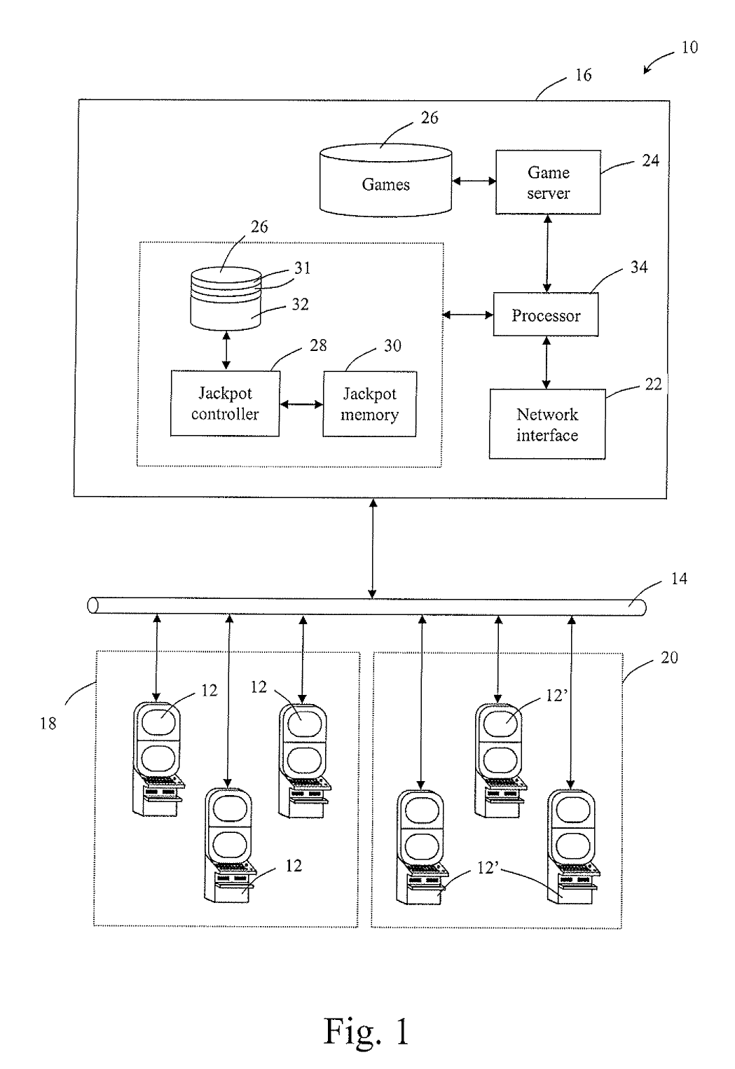

In the embodiment shown in FIG. 1, a first group of gaming machines 12 is disposed at a first gaming venue 18 and a second group of gaming machines 12′ is disposed at a second gaming venue 20. The second gaming venue 20 may be disposed at any location relative to the first gaming venue 18, such as in the same gaming complex, city or country, or in different cities or countries. For, example, the network 14 may comprise the Internet and the first and second gaming venues 18, 20 may be located in different countries.

The base station 16 comprises a network interface 22 arranged to facilitate communications to and from the base station 16, a game server 24 arranged to provide the gaming machines 12, 12′ with one or more games from a games repository 26 as required, and a jackpot controller 28 arranged to receive information indicative of credit contributions from the gaming machines 12, 12′ and to maintain a cumulative jackpot amount in a jackpot memory 30. The jackpot controller 28 also maintains records 31 of all gaming machines 12, 12′ currently associated with the gaming system and the respective locations of the gaming machines 12, 12′ in a locations database 32.

During operation, when a jackpot is won by a player of one of the gaming machines associated with the gaming system 10, all of or a portion of the jackpot amount indicated by the cumulative jackpot amount stored in the jackpot memory 30 is allocated to the winning gaming machine 12, 12′, and the location information stored in the locations database 32 is used to send communications to all gaming machines associated with the gaming system to indicate the location of the winning gaming machine. The location information can then be used by each gaming machine 12, 12′ to generate a zoom sequence on a display of the gaming machine, the zoom sequence progressively representing the location of the winning gaming machine with more specificity.

The base station 16 also includes a processor 34 arranged to control and coordinate operations in the base station, for example in association with suitable programs.

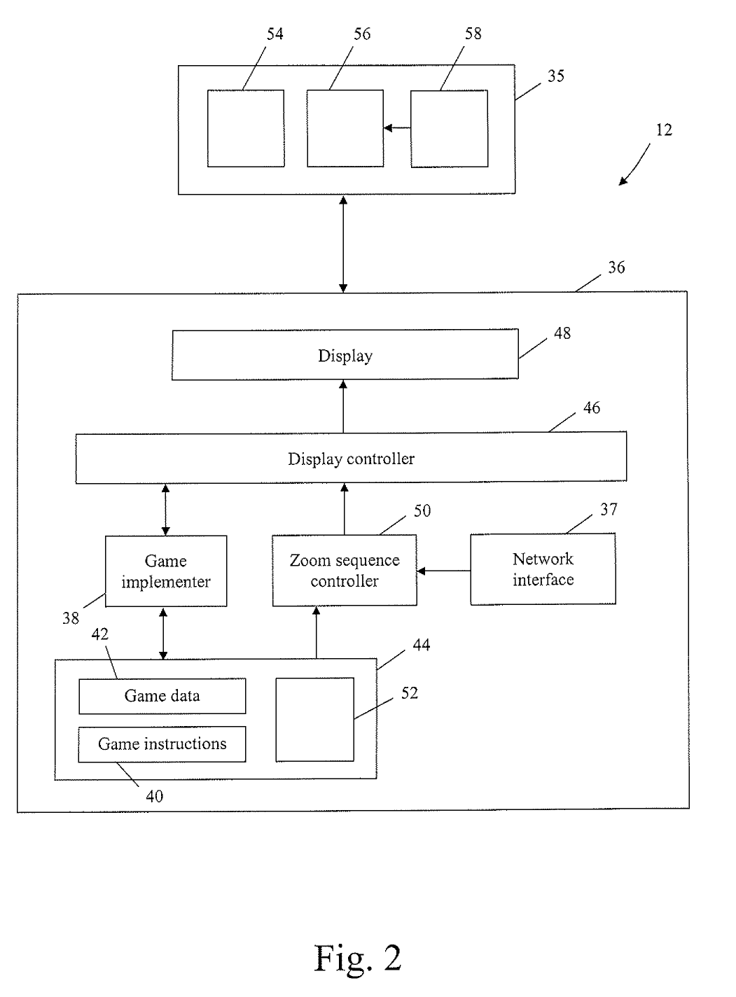

Example operative components of a gaming machine 12, 12′ are shown diagrammatically in FIG. 2. The components comprise a player interface 35 and a game controller 36.

The game controller 36 includes a network interface 37 which facilitates communications with the network and thereby with the base station 16, a game implementer 38 arranged to implement a game according to game instructions 40 and game data 42 stored in a memory 44, and a display controller 46 arranged to receive display information from the game implementer 38 and to cooperate with a display 48 so as to cause the display 48 to display a representation of the implemented game.

The gaming machine 12 also includes a zoom sequence controller 50 arranged such that when a communication is received from the base station 16 indicative of a jackpot winning gaming machine, the zoom sequence controller instructs the display controller 46 to cause a location representation indicative of the location of the winning gaming machine to be shown on the display 48. The location representation is in the form of a zoom sequence wherein the location representation is gradually modified such that the location of the winning gaming machine is progressively shown with more specificity. In this example, the location representation is derived from geographical metadata 52 stored in the memory 44, although it will be understood that location information for use in generating the location representation may be obtained in any suitable way.

The player interface 35 is arranged to enable interaction between a player and the gaming system and for this purpose includes input/output components required for the player to enter instructions and play the game.

Components of the player interface 35 may vary but will typically include a credit mechanism 54 to enable a player to input credits and receive payouts, one or more displays 56 which may comprise a touch screen, and a game play mechanism 58 arranged to enable a player to input game play instructions.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

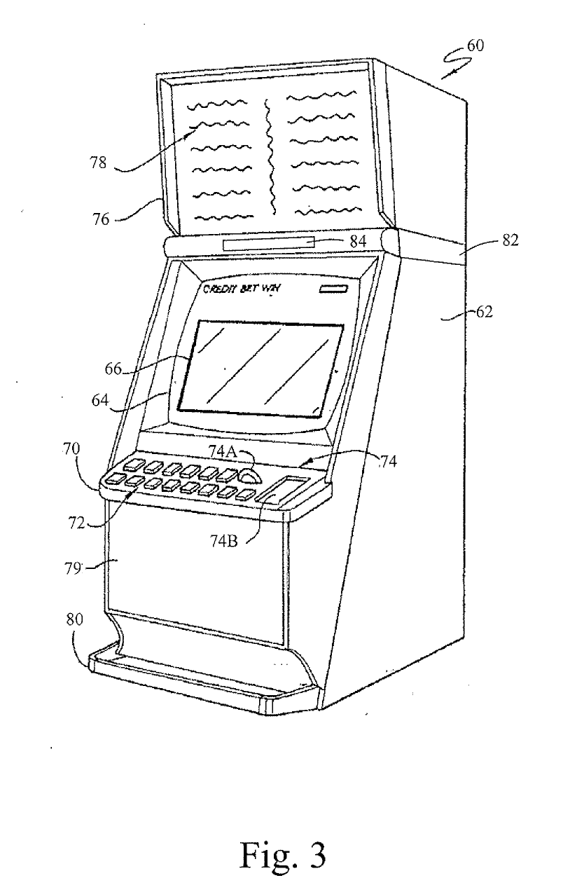

An example gaming machine 60 wherein most of the functions required to implement a game occur at the gaming machine is illustrated in FIG. 3. The gaming machine 60 includes a console 62 having a display 64 on which is displayed representations of a game 46 that can be played by a player. A mid-trim 70 of the gaming machine 60 houses a bank of buttons 72 for enabling a player to interact with the gaming machine, in particular during game play. The mid-trim 70 also houses a credit input mechanism 74 which in this example includes a coin input chute 74A and a bill acceptor 74B. Other credit input mechanisms may also be employed, for example, a card reader for reading a smart card, debit card or credit card.

A top box 76 may carry artwork 78, including for example pay tables and details of bonus awards and other information or images relating to the game. Further artwork and/or information may be provided on a front panel 79 of the console 62. A coin tray 80 is mounted beneath the front panel 79 for dispensing cash payouts from the gaming machine 60.

The display 64 is in the form of a video display unit, particularly a cathode ray tube screen device. Alternatively, the display 64 may be a liquid crystal display, plasma screen, or any other suitable video display unit. The top box 76 may also include a display, for example a video display unit, which may be of the same type as the display 64, or of a different type.

In this example, the game is a spinning reel type game and, accordingly, the display 64 is arranged to display representations of several reels, each reel of which has several associated symbols. Typically 3, 4 or 5 reels are provided. During operation of the game, the reels first appear to rotate then stop with typically three symbols visible on each reel. Game outcomes are determined on the basis of the visible symbols together with any special functions associated with the symbols, and if a function has been allocated to a reel, on the basis of the allocated function.

Alternative gaming machines including physical reels, and gaming machines arranged to implement other types of games such as bingo, keno, card games, or pin and ball games are also envisaged.

A player marketing module (PMM) 82 having a display 84 is connected to the gaming machine 60. The main purpose of the PMM 82 is to allow the player to interact with a player loyalty system. The PMM has a magnetic card reader for the purpose of reading a player identification device, for example as part of a loyalty program. However other reading devices may be employed and the player tracking device may be in the form of a card, flash drive or any other portable storage medium capable of being read by the reading device. In this example, the PMM 82 is a Sentinel III device produced by Aristocrat Technologies Pty Ltd.

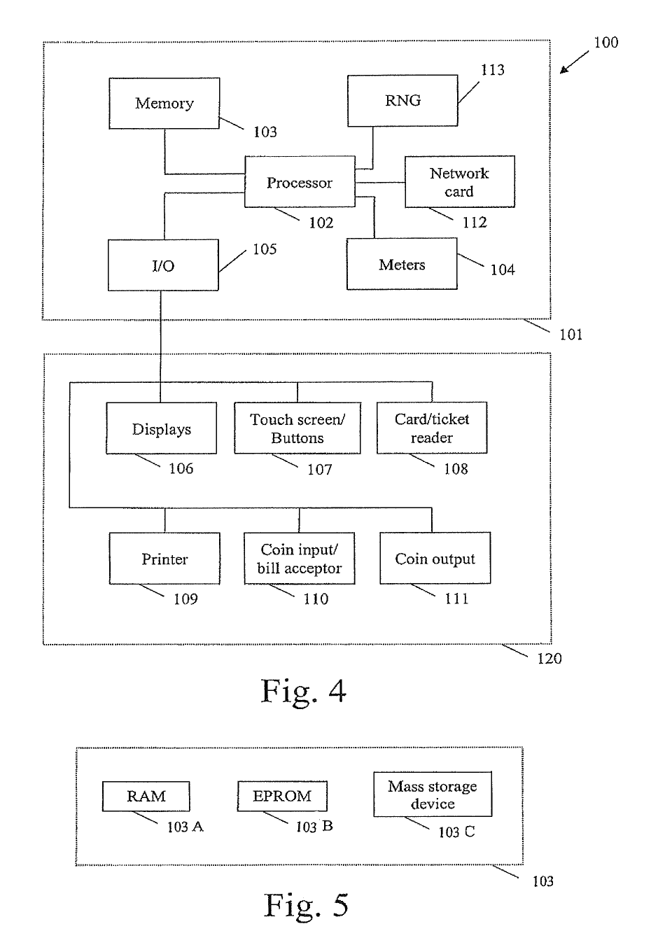

FIG. 4 shows a block diagram of example operative components 100 of the gaming machine 60 shown in FIG. 3.

The operative components 100 include a game controller 101 having a processor 102. Instructions and data to control operation of the processor 102 in accordance with the present invention are stored in a memory 103 which is in data communication with the processor 102.

Typically, the operative components 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

In this embodiment, the gaming machine also comprises hardware meters 104 for purposes including ensuring regulatory compliance and monitoring player credit, an input/output (I/O) interface 105 for communicating with a player interface 120 of the gaming machine 60, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and/or bank of buttons 107, a card and/or ticket reader 108, a printer 109, a bill acceptor and/or coin input mechanism 110 and a coin output mechanism 111. Additional hardware may be included as part of the gaming machine 60, or hardware may be omitted as required for the specific implementation.

In addition, the operative components 100 include a communications interface, for example a network card 112 which enables the gaming machine 60 to communicate with the gaming network 14.

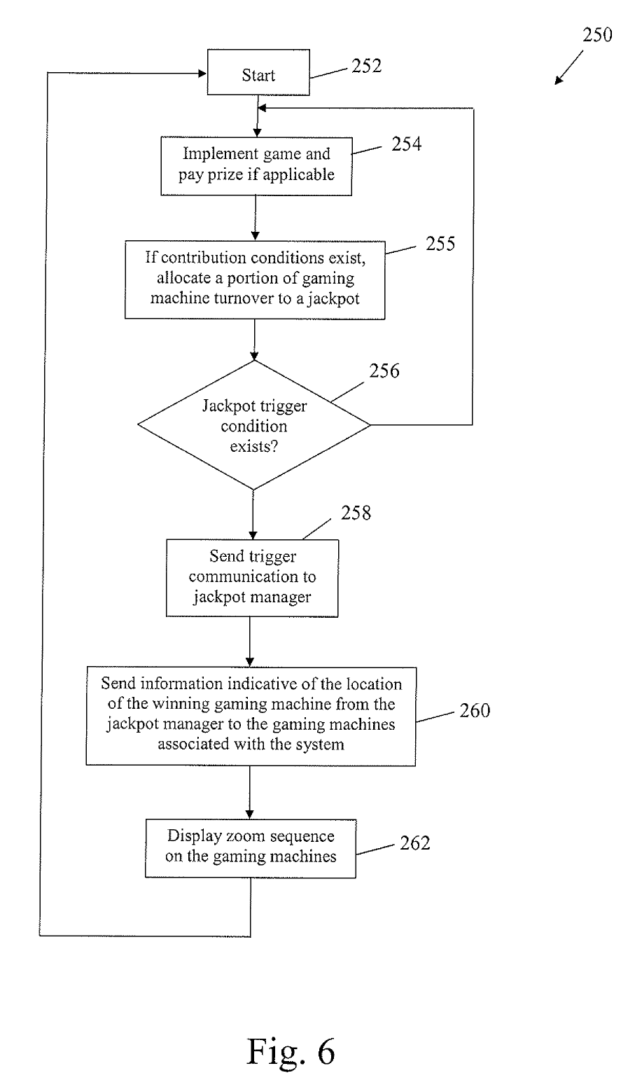

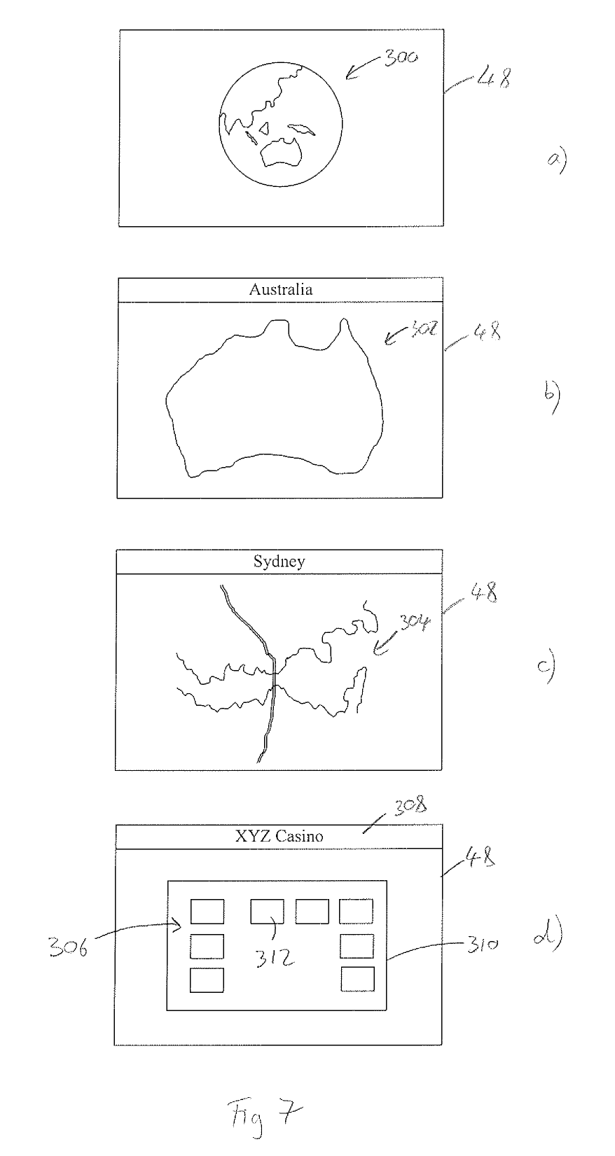

Operation of the gaming system 10 will now be described with reference to flow diagram 250 shown in FIG. 6 which illustrates steps 252 to 262 of a method of gaming in accordance with an embodiment of the invention.

As indicated at steps 252 and 254 in the flow diagram 250 illustrated in FIG. 6, games are implemented by respective gaming machines 12, 12′ and prizes are paid to players if applicable. During game play, if contribution conditions exist, such as a specified game turnover threshold is reached or a specific game outcome occurs, a credit amount is allocated to a jackpot amount maintained by the jackpot controller 28 so that the jackpot amount progressively increases until a jackpot trigger condition, such as a specific game outcome, exists at one of the gaming machines.

As indicated at steps 256 and 258, when a jackpot trigger condition exists, a trigger communication is sent from the gaming machine associated with the jackpot trigger condition to the jackpot controller 28 at the base station 16. On receipt of a trigger communication at the base station 16, the jackpot controller 28 in association with the processor 34 generates and sends a communication indicative of the location of the jackpot winning gaming machine to each of the gaming machines associated with the gaming system 10. Details of the gaming machines associated with the gaming system 10 such as the locations of the gaming machines and network addresses of the gaming machines are stored in the records 31 in the locations database 32.

As indicated at step 262 of the flow diagram 250, when the communication indicative of the location of the jackpot winning gaming machine is received at a gaming machine 12, 12′, the zoom sequence controller 50 cooperates with the display controller 46 using the geographical metadata 52 stored in the memory 44 so as to cause a representation of the location of the winning gaming machine to be displayed on the display 48. The zoom sequence controller 50 also causes the location representation to progressively display the location with more specificity such that a zoom in sequence effect is shown to a player.

The zoom sequence may be such that distinct zoom levels are displayed to a player as the location representation is displayed with more specificity. Alternatively, the zoom sequence may be such that a location representation is displayed to a player which smoothly changes the location representation.

As shown in FIGS. 7a to 7d, an example zoom sequence is illustrated wherein for a jackpot winning gaming machine located in a gaming venue in Lane Cove, Sydney, Australia, a representation of the southern hemisphere 300 may first be shown on the display, as shown in FIG. 7a. The representation is then modified so as to show the location of the winning gaming machine with more specificity by displaying a representation of Australia 302, as shown in FIG. 7b, then by showing a representation of Sydney 304, as shown in FIG. 7c, then by showing a representation of the layout 306 and name 308 of the gaming venue 310 in which the winning gaming machine 312 is located. The zoom sequence may continue until only a representation of the winning gaming machine is displayed, or the winning gaming machine 312 may be highlighted, for example by causing the representation of the winning gaming machine 312 to flash.

It will be appreciated that by indicating the location of a jackpot winning gaming machine on all gaming machines associated with the gaming system and displaying a zoom sequence which progressively shows the location with more specificity, the player gaming experience is enhanced.

In a variation of the gaming system 10, in addition to awarding a jackpot credit amount to a player of a gaming machine and displaying on all gaming machines a zoom sequence which terminates by displaying a representation of the winning gaming machine, the gaming system may be arranged such that at least one other gaming machine in addition to the jackpot triggering gaming machine also receives a proportion of the jackpot amount with the identity of the other gaming machine being communicated to all players by initiating an additional zoom sequence.

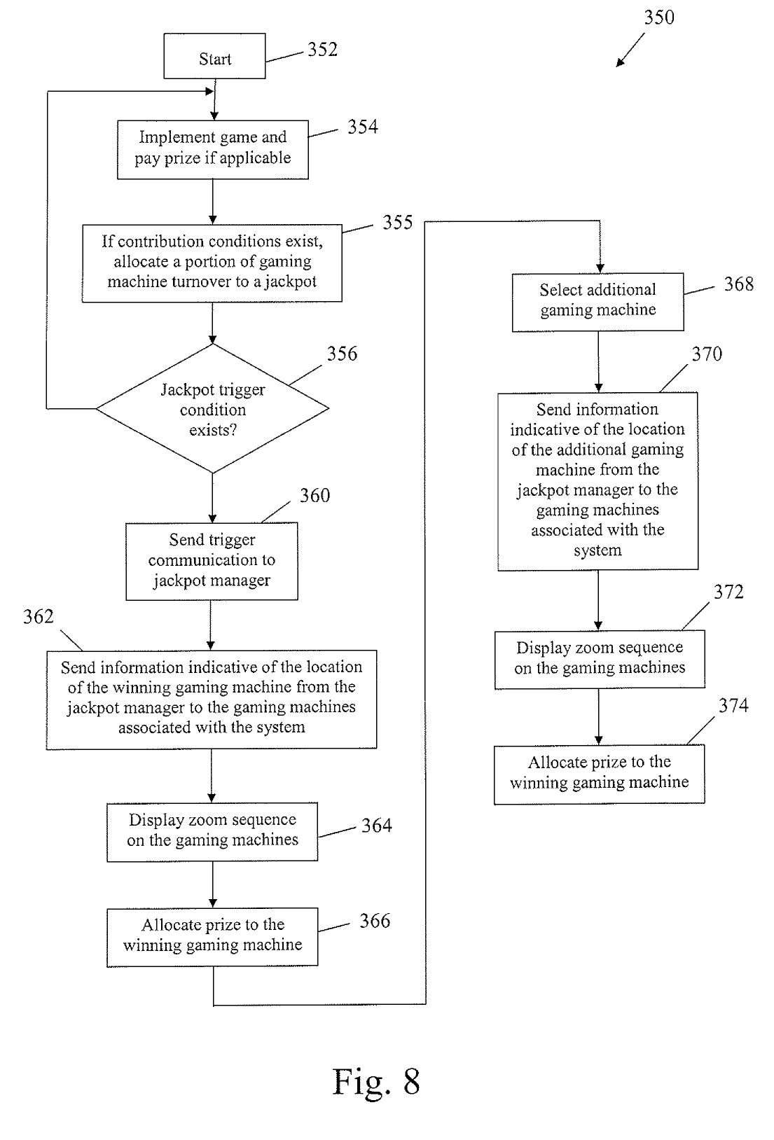

For example, as indicated in the flow diagram 350 in FIG. 8, games are implemented 354 by respective gaming machines 12, 12′ and prizes are paid 356 to players if applicable, as with the embodiment shown in the flow diagram 250 in FIG. 6. During game play, if contribution conditions exist, a credit amount is allocated to a jackpot amount maintained by the jackpot controller 28 so that the jackpot amount progressively increases until a jackpot trigger condition exists at one of the gaming machines. When a jackpot trigger condition exists, a trigger communication is sent 360 from the gaming machine associated with the jackpot trigger condition to the jackpot controller 28 at the base station 16 and a communication indicative of the location of the jackpot winning gaming machine is sent to each of the gaming machines associated with the gaming system 10. A zoom sequence which progressively displays the location of the jackpot winning gaming machine with more specificity then commences on each gaming machine.

After communicating the location of the primary jackpot winning gaming machine to players of the gaming machines 12, 12′, the jackpot controller 28 then selects, for example randomly, at least one other gaming machine associated with the system to receive at least a portion of the jackpot amount as a secondary prize. The identity of the selected additional gaming machine is then indicated to players of the gaming machines 12, 12′ by initiating a zoom sequence on the gaming machines 12, 12′ to progressively display the location of the additional jackpot winning gaming machine with more specificity.

The jackpot amount may be distributed between the primary and secondary winning gaming machines in any way. For example, the primary and secondary winning gaming machines may receive half of the current jackpot amount, or the first and second gaming machines may receive different amounts such as in a ratio of 1:2, 2:1, 1:5, 5:1 and so on.

While the above embodiments are described in relation to a gaming system wherein a zoom sequence is executed when at least one player wins a progressive type jackpot, it will be appreciated that other variations are possible. For example, the gaming machines associated with the gaming system may each be of a type wherein it is possible to win a relatively high jackpot credit amount but are not associated with a common jackpot. As with the previous embodiment, all gaming machines may be informed when one of the gaming machines wins the jackpot amount, and a zoom sequence commenced to indicate to players as to which machine has provided the jackpot. In this way, players of similar gaming machines are provided with a heightened sense of anticipation that a jackpot win may occur.

Modifications and variations as would be apparent to a skilled addressee are deemed to be within the scope of the present invention.

1. A gaming system comprising:
a plurality of gaming machines, each gaming machine being arranged to implement a probabilistic game and to determine when a winning outcome occurs;
a display; and
a zoom sequence implementer;
the gaming system being arranged to generate a win communication indicative of a winning gaming machine of the plurality of gaming machines when a specific winning outcome occurs at the winning gaming machine; and
the zoom sequence implementer being arranged to receive the win communication to cause location information indicative of the location of the winning gaming machine to be displayed on the display when the win communication is received, and to progressively modify the displayed location information such that the location of the winning gaming machine is progressively shown with more specificity.

2. A gaming system as claimed in claim 1, wherein the specific winning outcome is a credit win above a specific credit win amount threshold.

3. A gaming system as claimed in claim 1, comprising a jackpot controller arranged to manage a jackpot associated with the plurality of gaming machines and the specific winning outcome is a jackpot win by one of the gaming machines.

4. A gaming system as claimed in claim 3, wherein the jackpot is a progressive jackpot wherein each of the gaming machines contributes a portion of credit turnover to a jackpot amount.

5. A gaming system as claimed in claim 3, wherein the gaming system is arranged such that when a jackpot win is triggered by a first gaming machine, a first proportion of the jackpot amount is allocated to the first gaming machine, a second gaming machine is selected from the plurality of gaming machines, and a second proportion of the jackpot amount is allocated to the second gaming machine.

6. A gaming system as claimed in claim 5, wherein the first proportion is the same as the second proportion.

7. A gaming system as claimed in claim 5, wherein the first proportion is different to the second proportion.

8. A gaming system as claimed in claim 7, wherein the ratio of the first proportion to the second proportion is 1:2, 2:1, 1:5 or 5:1.

9. A gaming system as claimed in claim 1, wherein each gaming machine comprises a display and the zoom sequence implementer is arranged to cause the location information indicative of the location of the winning gaming machine to be displayed on the display.

10. A gaming system as claimed in claim 1, comprising at least one common display separate to the gaming machines, the zoom sequence implementer being arranged to receive the information indicative of a winning gaming machine associated with the gaming system and to cause location information indicative of the location of the winning gaming machine to be displayed on the common display.

11. A gaming system as claimed in claim 1, wherein the zoom sequence implementer is arranged to progressively modify the displayed location information such that the representation of the location of the winning gaming machine is progressively modified by consecutively displaying a plurality of distinct zoom levels.

12. A gaming system as claimed in claim 1, wherein the zoom sequence implementer is arranged to progressively modify the displayed location information such that the representation of the location of the winning gaming machine is progressively modified by smoothly changing the location representation.

13. A gaming system as claimed in claim 1, comprising a remote base station, wherein each gaming machine is arranged to generate information indicative of occurrence of a specific winning outcome and to communicate the information through the communications network to the remote base station, the remote base station using the information to generate the win communication and send the win communication to the plurality of gaming machines.

14. A gaming system as claimed in claim 13, wherein information indicative of the locations of the gaming machines is stored at the base station and used to send the win communication to the plurality of gaming machines.

15. A gaming system as claimed in claim 1, wherein the information indicative of occurrence of a specific winning outcome generated by a gaming machine is communicated directly to all gaming machines associated with the gaming system, the information indicative of occurrence of a specific winning outcome including information indicative of the location of the winning gaming machine.

16. A gaming machine for a gaming system including a plurality of gaming machines, the gaming machine being arranged to implement a probabilistic game, the gaming machine comprising:
an interface arranged to receive information indicative of a winning gaming machine;
a display; and
a zoom sequence implementer arranged to cause display of location information indicative of the location of the winning gaming machine to be displayed when information indicative of the winning gaming machine is received, and to progressively modify the displayed location information such that the location of the winning gaming machine is progressively shown with more specificity.

17. A method of gaming, comprising:
providing a plurality of gaming machines;
implementing a probabilistic game at least one gaming machines;
determining whether a winning outcome occurs at the at least one gaming machine;
generating information indicative of a winning gaming machine when a specific winning outcome occurs at the winning gaming machine;
displaying location information indicative of the location of the winning gaming machine when information indicative of the winning gaming machine is received; and
progressively modifying the displayed location information such that the location of the winning gaming machine is progressively shown with more specificity.

18. A computer program arranged when loaded into a computing device to instruct the computing device to operate in accordance with a gaming machine comprising:
an interface arranged to receive information indicative of a winning gaming machine associated with a gaming system;
a display; and
a zoom sequence implementer arranged to cause display location information indicative of the location of the winning gaming machine to be displayed when information indicative of the winning gaming machine is received, and to progressively modify the displayed location information such that the location of the winning gaming machine is progressively shown with more specificity.

19. A computer readable medium having computer readable program code embodied therein for causing a computing device to operate in accordance with a gaming machine comprising:
an interface arranged to receive information indicative of a winning gaming machine associated with a gaming system;
a display; and
a zoom sequence implementer arranged to cause display location information indicative of the location of the winning gaming machine to be displayed when information indicative of the winning gaming machine is received, and to progressively modify the displayed location information such that the location of the winning gaming machine is progressively shown with more specificity
